(19) United States
(12) Patent Application Publication
(10) Pub. No.: US 2014/0372948 A1
(43) Pub. Date: Dec. 18, 2014

(54) Persistent Reverse Navigation Mechanism

(71) Applicant: Microsoft Corporation, Redmond, WA (US)

(72) Inventor: Han-Yi Shaw, Redmond, WA (US)

(21) Appl. No.: 13/918,915

(22) Filed: Jun. 15, 2013

(51) Int. Cl. G06F 3/0482

(52) U.S. Cl. CPC G06F 3/0482
USPC 715/817

(57) ABSTRACT

Persistent feedback for bidirectional navigation is provided. A user may navigate from a list of items in a first user interface to a second user interface where a specific item from the list of items may be opened. When the user navigates back to the first user interface, the item which the user opened in the second user interface may be marked with a persistent visual indicator. The persistent visual indicator provides an indication to the user which item he previously had opened. The persistent visual indicator may be functionally selectable, which when selected, may reopen the item it is associated with in the second user interface.

### BACKGROUND

Oftentimes when using a computer software application, a user may navigate between hierarchies. For example, a user may navigate from a list of items, such as documents, to a specific item in the list, and then the reverse (i.e., from the specific item back to the list of items). When performing such an action, the user may become lost when navigating from the specific item back to the list of items. With current systems, a visual indication of the specific item previously navigated to may not be provided; or if a visual indication is provided, it may only be provided for a short duration (e.g., may fade out, may be an animation, etc.). Accordingly, the user may miss the visual clue and/or not be aware of which item from which he has just navigated. As can be appreciated, this may be frustrating for a user.

Additionally, in certain operating systems, such as a touch-based table operating system, a forward functionality control may not be provided. If a user is not sure of which item he previously opened, he may not be able to select a forward functionality control to navigate back to specific item.

It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing persistent feedback for bidirectional navigation. A list of items may be stored in a first user interface. A user may navigate between the first user interface and a second user interface by selecting an item from the list to open. When the user navigates back to the first user interface, for example, by selecting a back button, the item which the user opened in the second user interface may be marked with a persistent visual indicator, for example, a forward button, indicating to the user which item he previously had opened. According to an embodiment, the persistent visual indicator may be a selectable control, which when selected, may reopen the item it is associated with in the second user interface.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various embodiments of the present invention. In the drawings:

FIG. 1 is a simplified block diagram of a system providing persistent feedback for bidirectional navigation;

FIG. 2 is an illustration of an example doc stage user interface displayed on a tablet device;

FIG. 3 is an illustration of an example editing stage user interface;

FIG. 4 is an illustration of the example doc stage user interface of FIG. 2 after transitioning from the editing stage user interface;

FIGS. 5A and 5B are illustrations of the example doc stage user interface of FIG. 4 including a persistent visual indicator;

FIG. 6 a flow chart of a method for providing persistent feedback for bidirectional navigation;

FIG. 7 is a block diagram illustrating example physical components of a computing device with which embodiments of the invention may be practiced;

FIGS. 8A and 8B are simplified block diagrams of a mobile computing device with which embodiments of the present invention may be practiced; and

FIG. 9 is a simplified block diagram of a distributed computing system in which embodiments of the present invention may be practiced.

### DETAILED DESCRIPTION

As briefly described above, embodiments of the present invention are directed to providing persistent feedback for bidirectional navigation. Consider, for example, a user is using a notes application. A first user interface may be displayed comprising a list of notebooks. He may select a notebook to view or edit one or more notes within the selected notebook. Accordingly, the selected notebook may be opened in a second UI. The user may view or edit notes in the notebook, and may wish to share a note from the notebook with another user. To do this, the user may select a back button to return to the first user interface, where sharing options may be provided. With current systems, if the user has multiple notebooks, he may not be aware of which notebook he just had opened.

Embodiments of the present invention provide a persistent reverse navigation mechanism, wherein upon navigating back to the first user interface, a visual indicator may be provided for informing the user from which item he navigated. The visual indicator may persist until a subsequent action is made by the user.

The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

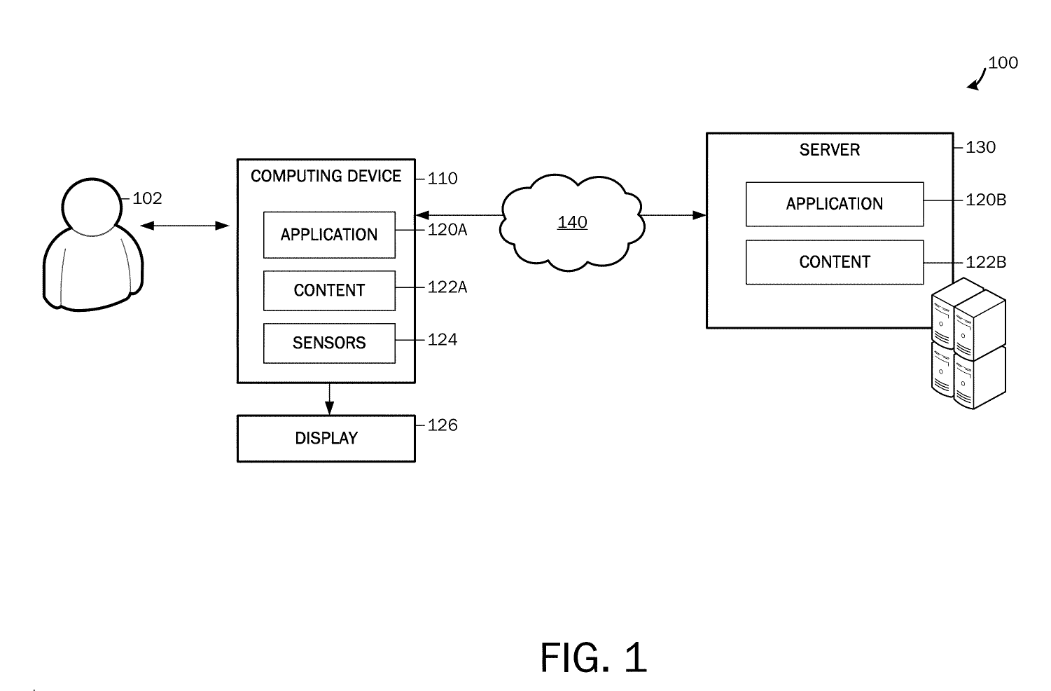

Referring now to the drawings, in which like numerals represent like elements, various embodiments will be described. FIG. 1 is a block diagram illustrating a network architecture 100 for providing persistent reverse navigation, in accordance with various embodiments. The network architecture 100 includes a computing device 110. The computing device 110 may be one of various types of computing devices (e.g., a tablet computing device, a desktop computer, a mobile communication device, a laptop computer, a laptop/tablet hybrid computing device, or other types of computing devices) for executing applications 120 for performing a variety of tasks.

A user 102 may utilize an application 120 on a computing device 110 for a variety of tasks, which may include, for example, to write, calculate, draw, organize, prepare presentations, send and receive electronic mail, take and organize notes, make music, and the like. Applications 120 may include thick client applications 120A which may be stored locally on the computing device 110, or may include thin client applications (i.e., web applications 120B) that may reside on a remote server 130 and accessible over a network 140, such as the Internet or an intranet. A thin client application 120B may be hosted in a browser-controlled environment or coded in a browser-supported language and reliant on a common web browser to render the application executable on a computing device 110. The computing device 110 may be configured to receive content 122 for presentation as one or more images on a display 126 (which may comprise a touch screen display).

An application 120 may be configured to enable a user 102 to use a pointing device and/or to utilize sensors 124 on the computing device 110 to interact with content 122 via a number of input modes. In accordance with an embodiment, the sensors 124 may comprise a touch sensor. Other types of sensors (e.g., accelerometer, hover, facial recognition, voice recognition, etc.) may also be utilized. For example, a graphical user interface associated with an application 120 may be navigated using touch. To assist users to locate and utilize functionalities of a given application 120, a user interface (UI) containing a plurality of selectable functionality controls may be provided. According to embodiments, a UI may also include visual indicators for providing information to a user. For example and as will be described in greater detail below, when a user 102 opens an item in a list and subsequently returns to the list, a persistent visual indicator may be displayed with the item in the list to indicate to the user 102 the item from which he has just navigated.

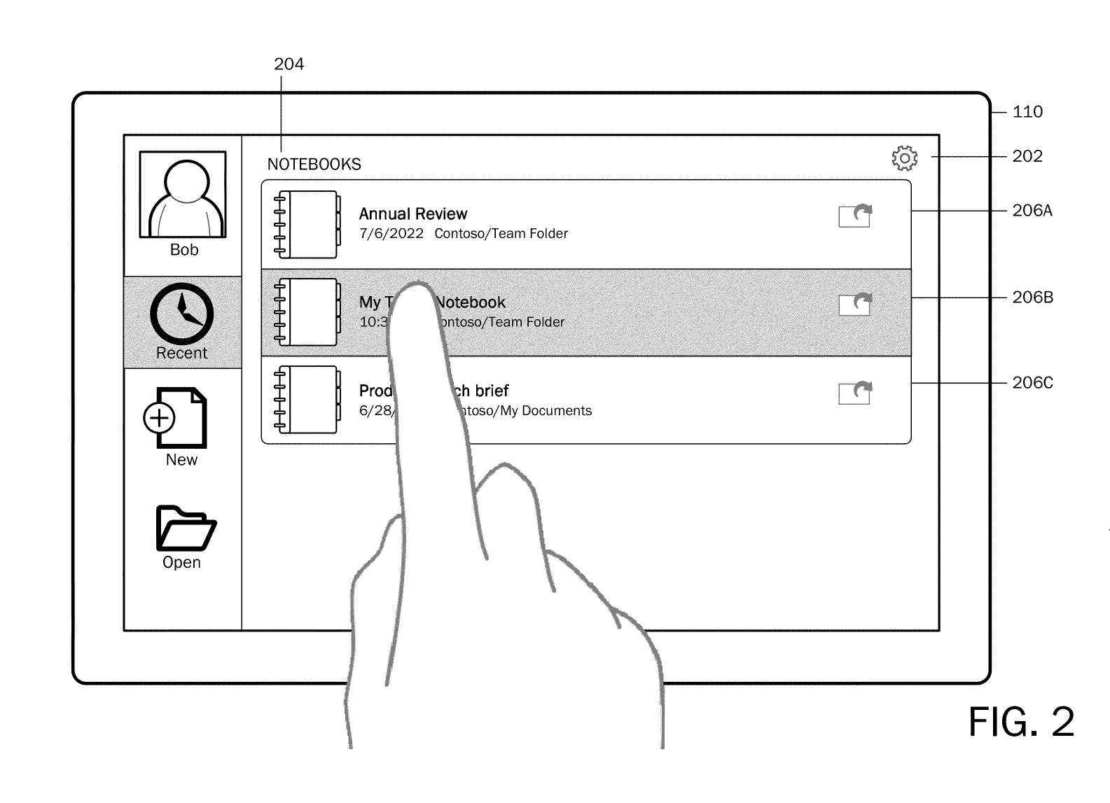

Referring now to FIG. 2, an example application user interface comprising a list 204 of items 206 is shown displayed on a tablet computing device 110. It should be understood that the tablet computing device 110 is illustrated for purposed of example only, and a vast number of types of computing devices, with various types of input mechanisms and sensors 124 may be used for providing persistent feedback for bidirectional navigation in accordance with embodiments of the present invention. In an application 120, various items 206, which may include, but are not limited to, documents, emails, pictures, or other types of content items that may be provided in a list 204, may be staged in a documents stage user interface (UI), herein referred to as a docs stage UI 202. The docs stage UI 202 may comprise a list 204 of items 206, and may include additional information, such as a last modified date and time, document type, document size, etc. In the example illustrated in FIG. 2, the application 120 is a notes application, and the docs stage UI 202 includes a list 204 of notebooks (items 206), which may be selectably opened. As should be understood, embodiments are not limited to a notes application, but may include various types of applications for performing various tasks.

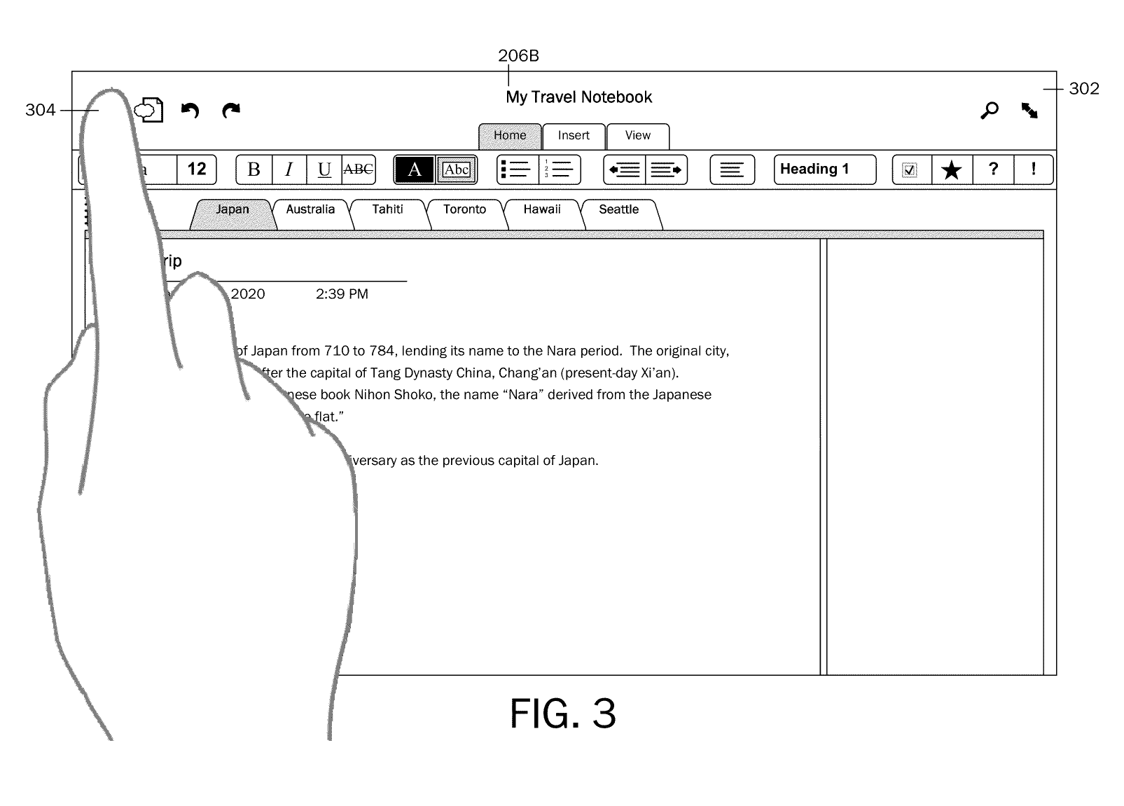

A user 102 may select an item 206 from a list 204 to open the item. As illustrated in FIG. 2, a user 102 is selecting a notebook (item 206B) from the list 204 of notebooks. When an item 206 is opened, it may be opened in a second UI, for example, an editing stage UI 302 as illustrated in FIG. 3. The second UI may comprise various types of environments. For example, according to one embodiment, the second UI may be an editing environment for allowing editing of an item 206. According to another embodiment, the second UI may be an environment for viewing an item 206 (e.g., viewing a picture). According to another embodiment, the second UI may be an environment for consuming an item 206 (e.g., playing music, playing video, etc.).

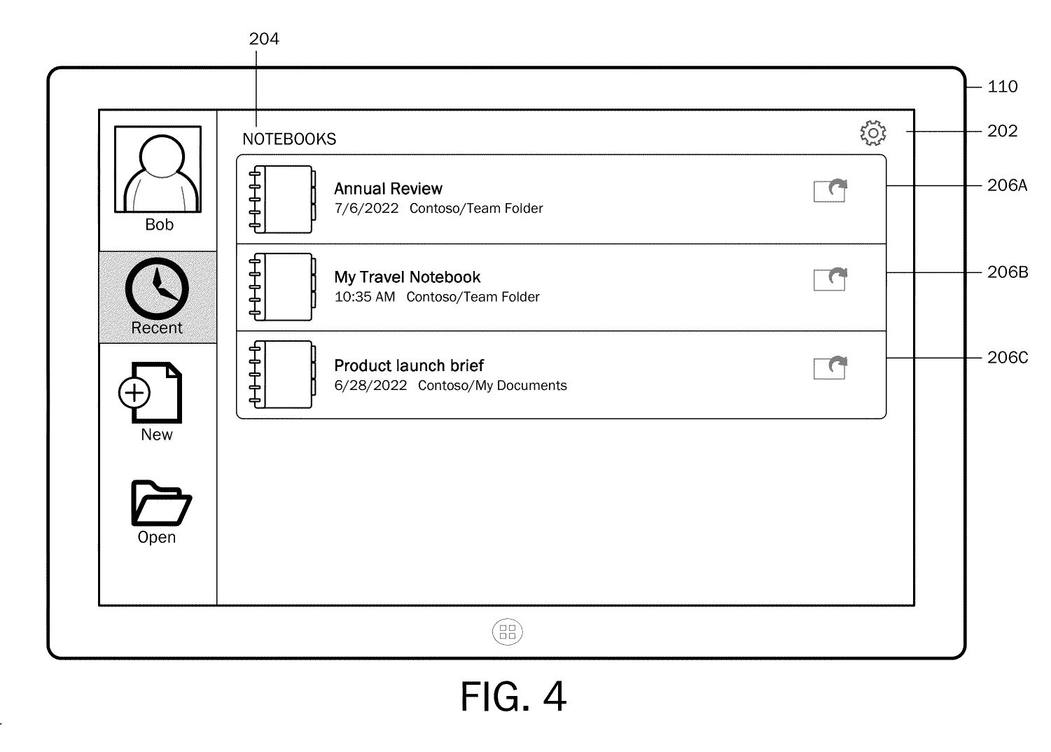

A user 102 may navigate back to the docs stage UI 202 from the second UI (e.g., editing stage UI 302), for example, by selecting a back button 304. As described above, and as illustrated in FIG. 4, with current systems, when a user 102 returns to the docs stage UI 202, a visual indication of reverse navigation may not be provided. Accordingly, the user 102 may be unaware of the item 206 from which he came (i.e., the item 206 previously opened in the second UI). Current systems may either not include a visual indication of reverse navigation, or if a visual indication is provided, it may only be provided for a short duration (e.g., may fade out, may be an animation, etc.). The user 102 may miss the visual clue, and may be left with a list 204 and not know which item 206 he previously selected. As can be appreciated, this may be frustrating for a user 102.

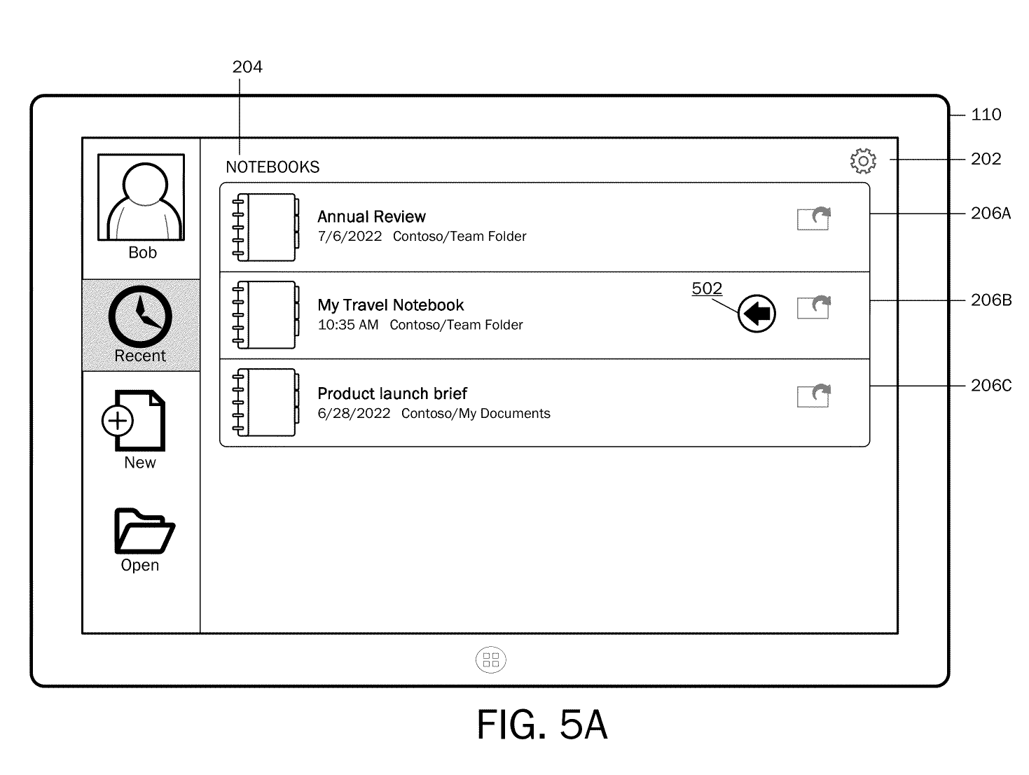

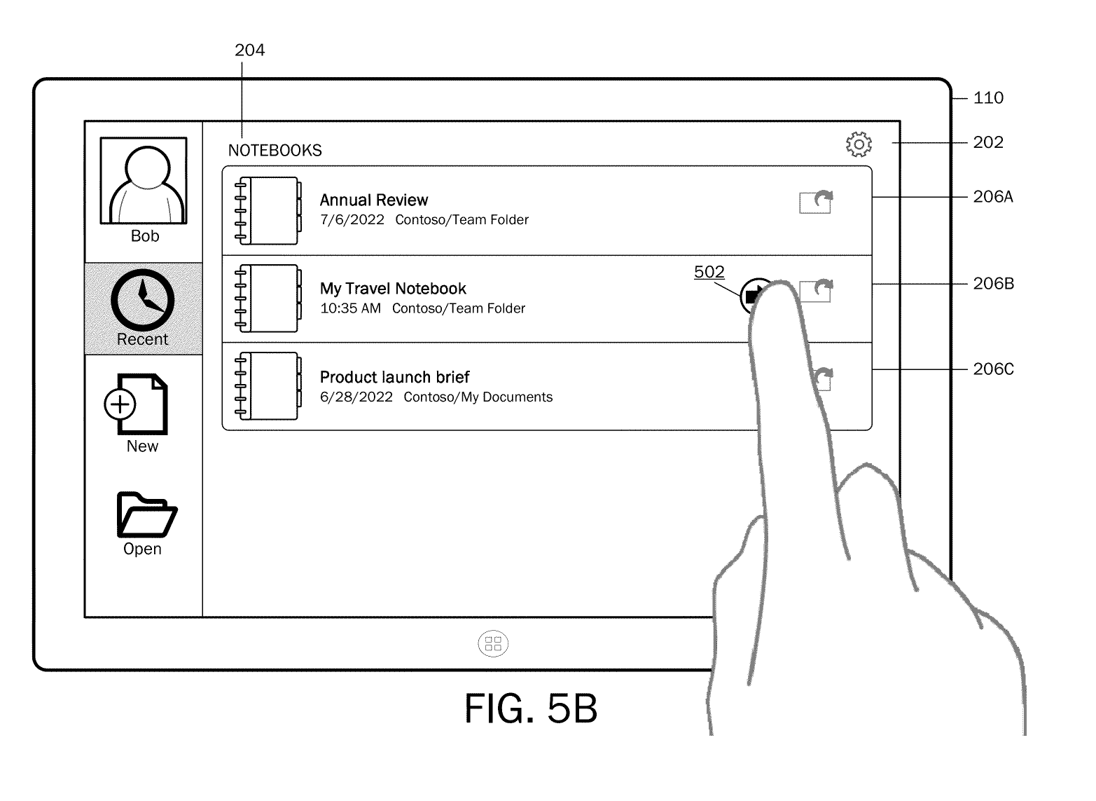

Embodiments of the present invention provide a persistent reverse navigation mechanism for providing an indication to a user 102 of an item 206 from which he has navigated. Referring now to FIGS. 5A and 5B, the docs stage UI 202 of FIGS. 2 and 4 is shown including a visual indicator 502, the visual indicator 502 providing an indication of the item 206 from which the user 102 has navigated and which was previously opened in the second UI (e.g., editing stage UI 302). For example and as illustrated in FIGS. 5A and 5B, a visual indicator 502 is provided with a notebook (item 206B), indicating that the notebook (item 206B) is the item 206 from which he navigated back. According to embodiments, the visual indicator 502 is persistent. That is, the visual indicator 502 may not disappear or animatedly fade from view until the user 102 makes another selection, for example, until the user 102 selects another item 206 to open. The visual indicator 502 may be visually displayed in a vast number of ways. For example and as illustrated in FIGS. 5A and 5B, the visual indicator 502 may be in the form of an arrow.

According to an embodiment, the visual indicator 502 may include animation. For example, as illustrated in FIG. 5A, when the application 120 transitions from the second UI 302 to the docs stage UI 202, the visual indicator 502 may appear in one form, such as a back button. As illustrated in FIG. 5B, after a predetermined amount of time, the visual indicator 502 may animate into a second form, such as a forward button. According to another embodiment, the visual indicator 502 may be functionally selectable. For example, if the visual indicator 502 transitions into a forward button, the user 102 may select the visual indicator 502 to reopen the item 206B in the second UI (e.g., editing stage UI 302).

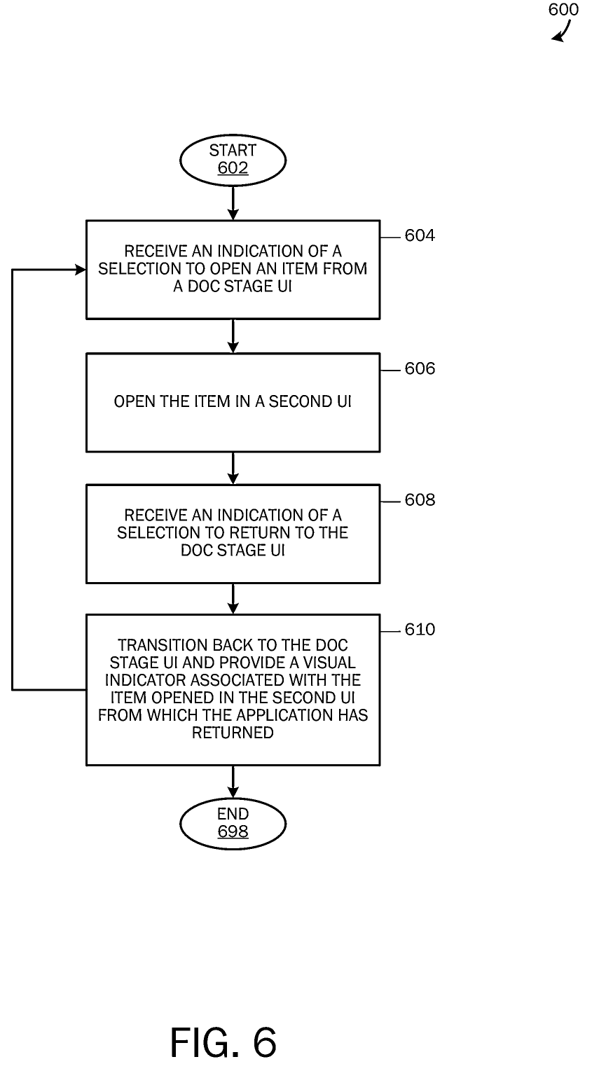

FIG. 6 is a flow chart showing one embodiment of a method 600 for providing persistent feedback for bidirectional navigation. The method 600 starts at OPERATION 602 and proceeds to OPERATION 604 where an indication of a selection to open an item 206 from a doc stage UI 202 is received. As described above, items 206 may include, but are not limited to, documents, emails, pictures, or other types of content items that may be provided in a list 204. The doc stage UI 202 may be a UI comprising a list 204 of items 206, and may include additional information, such as a last modified date and time, document type, document size, etc. The item 206 may be selected via various ways known in the art, and may depend on a type of input method supported by a computing device 110 being used. For example, if the computing device supports Natural User Interface (NUI) methods, for example, comprises interface technology that enables a user 102 to interact with the computing device 110 in a “natural” manner, free from artificial constraints imposed by input devices such as mice, keyboards, remote controls, and the like, the user 102 may select an item 206 from the list 204 via such methods as touch, stylus, gesture (both on screen and adjacent to the screen), air gestures, head and eye tracking, etc.

Upon receiving an indication of a selection to open the item 206, the method 600 may proceed to OPERATION 606, where the item 206 may be opened in a second UI, for example, an editing stage UI 302. In the second UI, the user 102 may perform various functionalities, such as viewing the item 206, editing the item 206, if the item 206 is a media item, the user 102 may consume (e.g., watch, listen to, etc.) the item 206, etc.

At OPERATION 608, an indication of a selection to return to the previous UI (i.e., the doc stage UI 202) may be received. The user 102 may choose to return to the doc stage UI 202 for various reasons. For example, the user 102 may return to the doc stage UI 202 to access a functionality option in the doc stage UI, or to open another item 206.

The method 600 may proceed to OPERATION 610, where the UI may transition back to the doc stage UI 202, and a visual indicator 502 may be displayed with the item 206 that was opened in the second UI prior to the transition to the doc stage UI 202. The visual indicator 502 may persist until a subsequent action is taken by the user 102. The method 600 may return to OPERATION 604 where the user 102 may select the same item 206 or another item 206 from the list 204 in the doc stage UI 202. As described above, the visual indicator 502 may be functionally selectable. If the visual indicator 502 comprises a functionality to reopen the item 206 with which it is associated, at OPERATION 604, the user 102 may select the visual indicator 502 to reopen the item 206 in the second UI. The method 600 may repeat OPERATIONS 604-610, or may end at OPERATION 698.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

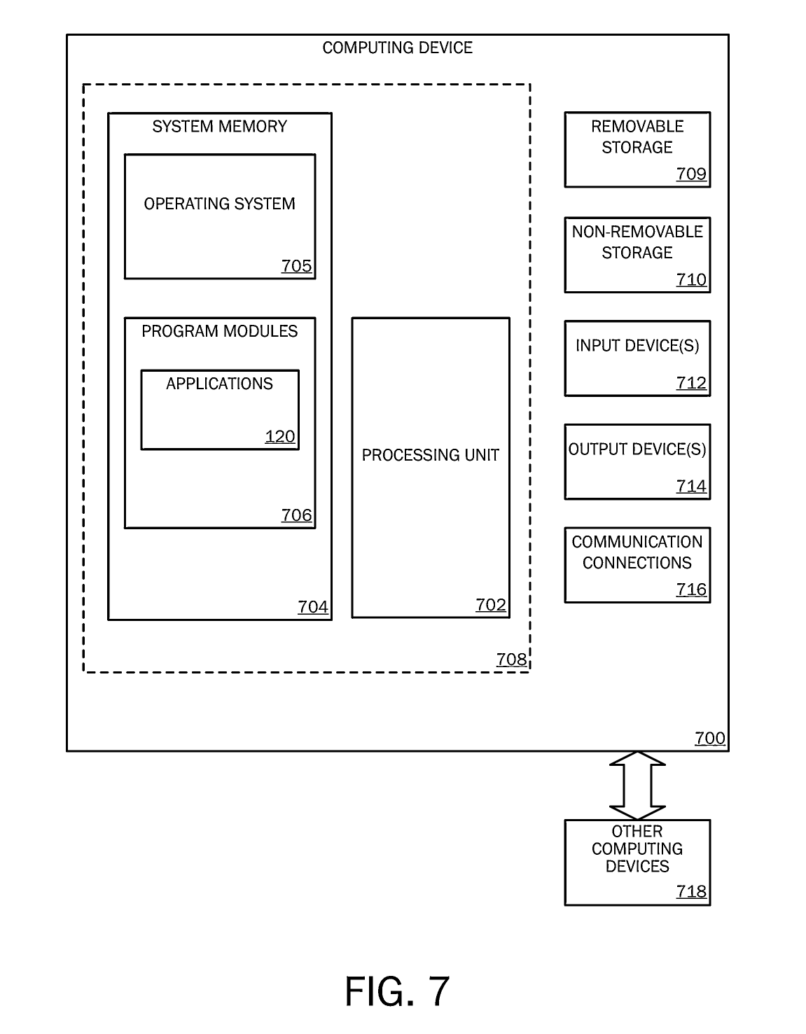

FIGS. 7-9 and the associated descriptions provide a discussion of a variety of operating environments in which embodiments of the invention may be practiced. However, the devices and systems illustrated and discussed with respect to FIGS. 7-9 are for purposes of example and illustration and are not limiting of a vast number of computing device configurations that may be utilized for practicing embodiments of the invention, described herein.

FIG. 7 is a block diagram illustrating physical components (i.e., hardware) of a computing device 700 with which embodiments of the invention may be practiced. The computing device components described below may be suitable for the computing devices described above. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running software applications 120 such as a notes application. The operating system 705, for example, may be suitable for controlling the operation of the computing device 700. Furthermore, embodiments of the invention may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 may perform processes including, but not limited to, one or more of the stages of the method 600 illustrated in FIG. 6. Other program modules that may be used in accordance with embodiments of the present invention may include applications 120, such as, electronic mail and contacts applications, word processing applications, spreadsheet applications, database applications, slide presentation applications, notes applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, may be operated via application-specific logic integrated with other components of the computing device 700 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 700 may also have one or more input device(s) 712 such as a keyboard, a mouse, a pen, a sound input device, a touch input device, etc. The output device(s) 714 such as a display, speakers, a printer, etc. may also be included. The aforementioned devices are examples and others may be used. The computing device 700 may include one or more communication connections 716 allowing communications with other computing devices 718. Examples of suitable communication connections 716 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700.

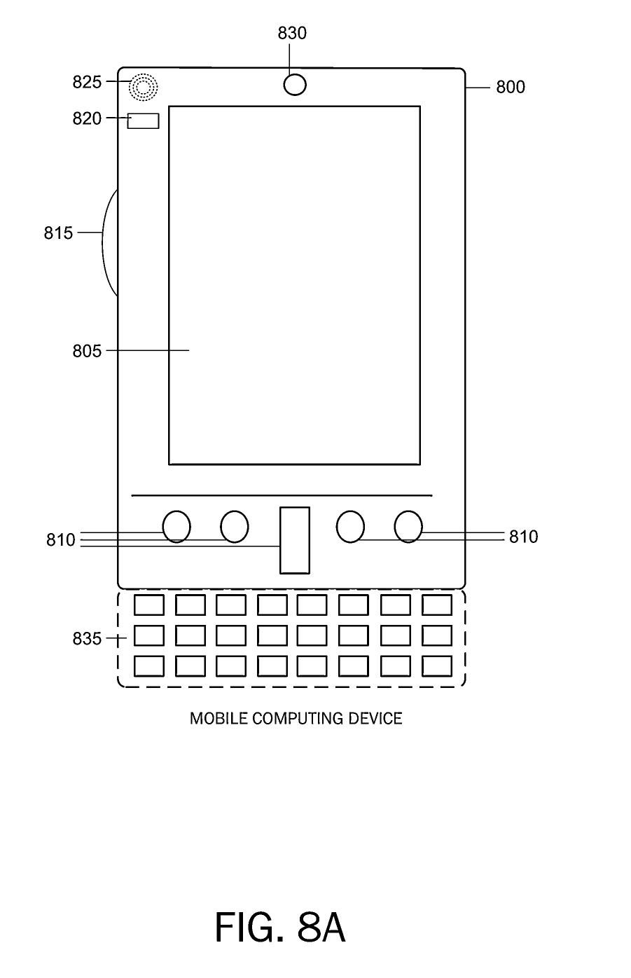

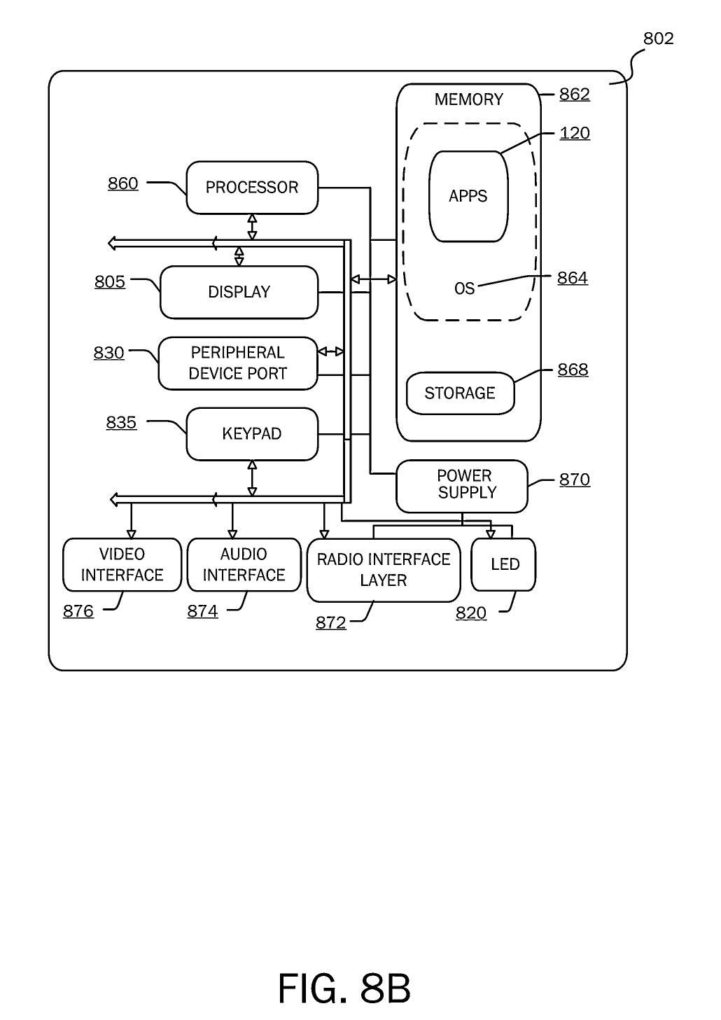

FIGS. 8A and 8B illustrate a mobile computing device 800, for example, a mobile telephone, a smart phone, a tablet personal computer, a laptop computer, and the like, with which embodiments of the invention may be practiced. With reference to FIG. 8A, one embodiment of a mobile computing device 800 for implementing the embodiments is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative embodiments, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some embodiments, the mobile computing device 800 incorporates a vibration transducer for providing the user with tactile feedback. In yet another embodiment, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one embodiment of a mobile computing device. That is, the mobile computing device 800 can incorporate a system (i.e., an architecture) 802 to implement some embodiments. In one embodiment, the system 802 is implemented as a “smart phone” capable of running one or more applications (e.g., browser, e-mail, calendaring, contact managers, messaging clients, games, and media clients/players). In some embodiments, the system 802 is integrated as a computing device, such as an integrated personal digital assistant (PDA) and wireless phone.

One or more application programs 120 may be loaded into the memory 862 and run on or in association with the operating system 864. Examples of the application programs include phone dialer programs, e-mail programs, personal information management (PIM) programs, notes applications, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 120 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800.

The system 802 has a power supply 870, which may be implemented as one or more batteries. The power supply 870 might further include an external power source, such as an AC adapter or a powered docking cradle that supplements or recharges the batteries.

The system 802 may also include a radio 872 that performs the function of transmitting and receiving radio frequency communications. The radio 872 facilitates wireless connectivity between the system 802 and the “outside world,” via a communications carrier or service provider. Transmissions to and from the radio 872 are conducted under control of the operating system 864. In other words, communications received by the radio 872 may be disseminated to the application programs 120 via the operating system 864, and vice versa.

The visual indicator 820 may be used to provide visual notifications and/or an audio interface 874 may be used for producing audible notifications via the audio transducer 825. In the illustrated embodiment, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with embodiments of the present invention, the microphone may also serve as an audio sensor to facilitate control of notifications, as will be described below. The system 802 may further include a video interface 876 that enables an operation of an on-board camera 830 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio 872 or via a distributed computing network. Similarly, such data/information may be readily transferred between computing devices for storage and use according to well-known data/information transfer and storage means, including electronic mail and collaborative data/information sharing systems.

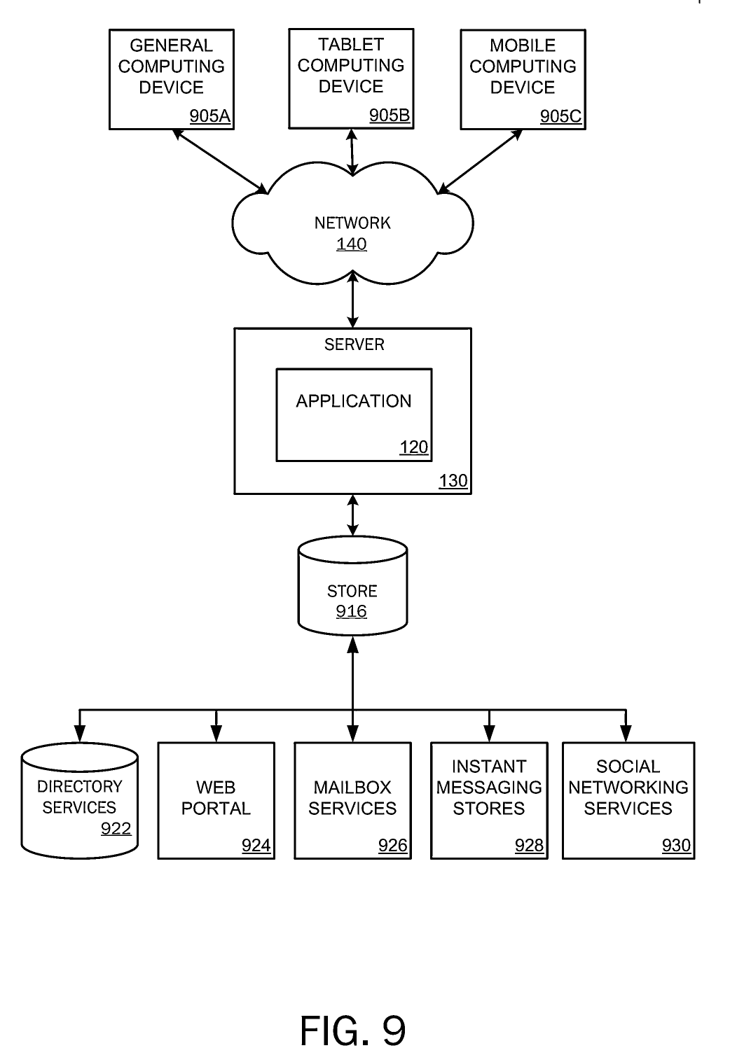

FIG. 9 illustrates one embodiment of the architecture of a system for providing an improved dynamic user interface, as described above. Content developed, interacted with, or edited in association with an application 120 may be stored in different communication channels or other storage types. For example, various documents may be stored using a directory service 922, a web portal 924, a mailbox service 926, an instant messaging store 928, or a social networking site 930. The application 120 may use any of these types of systems or the like for enabling data utilization, as described herein. A server 130 may provide the application 120 to clients. As one example, the server 130 may be a web server providing the application 120 over the web. The server 130 may provide the application 120 over the web to clients through a network 140. By way of example, the client computing device may be implemented and embodied in a personal computer 905A, a tablet computing device 905B and/or a mobile computing device 905C (e.g., a smart phone), or other computing device 110. Any of these embodiments of the client computing device 905A, 905B, 905C, 110 may obtain content from the store 916.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A method for providing persistent feedback for bidirectional navigation, the method comprising:
providing a list of a plurality of items in a first user interface;
receiving an indication of a selection to open an item from the list in the first user interface;
opening the item in a second user interface;
receiving an indication of a selection to return to the first user interface;
transitioning back to the first user interface; and
providing a persistent visual indicator associated with the item opened in the second user interface.

2. The method of claim 1, wherein providing a persistent visual indicator associated with the item opened in the second user interface comprises providing a persistent visual indicator in-line with the item in the list in the first user interface.

3. The method of claim 1, wherein providing a persistent visual indicator associated with the item opened in the second user interface comprises providing a functionally selectable persistent visual indicator.

4. The method of claim 3, further comprising:
receiving an indication of a selection of the functionally selectable persistent visual indicator; and
reopening the item in the second user interface.

5. The method of claim 3, wherein providing a persistent visual indicator associated with the item opened in the second user interface comprises providing an animated visual indicator.

6. The method of claim 5, wherein providing an animated visual indicator comprises providing a back button animating into a selectable forward button.

7. The method of claim 1, wherein providing a list of a plurality of items in a first user interface comprises providing a list of application items, the application items comprising one or more of:
documents;
notebooks;
media files;
emails; or
photos.

8. The method of claim 1, wherein opening the item in a second user interface comprises opening the item in one of:
an editing stage user interface;
a viewing stage user interface; or
a consumption stage user interface.

9. A system for providing persistent feedback for bidirectional navigation, the system comprising:
one or more processors; and
a memory coupled to the one or more processors, the one or more processors operable to:
provide a list of a plurality of items in a first user interface;
receive an indication of a selection to open an item from the list in the first user interface;
open the item in a second user interface;
receive an indication of a selection to return to the first user interface;
transition back to the first user interface; and
provide a persistent visual indicator associated with the item opened in the second user interface.

10. The system of claim 9, wherein the processor, in providing a persistent visual indicator associated with the item opened in the second user interface, is operable to provide the persistent visual indicator in-line with the item in the list in the first user interface.

11. The system of claim 9, wherein the processor, in providing a persistent visual indicator associated with the item opened in the second user interface, is operative to provide a functionally selectable persistent visual indicator.

12. The system of claim 11, wherein the processor is further operative to:
receive an indication of a selection of the functionally selectable persistent visual indicator; and
reopen the item in the second user interface.

13. The system of claim 11, wherein the processor, in providing a persistent visual indicator associated with the item opened in the second user interface, is further operative to provide an animated visual indicator.

14. The system of claim 13, wherein the processor, in providing an animated visual indicator, is operative to provide a back button animating into a selectable forward button.

15. The system of claim 9, wherein the list of a plurality of items in a first user interface comprises a list of application items, the application items comprising one or more of:
documents;
notebooks;
media files;
emails; or
photos.

16. The system of claim 9, wherein the processor, in opening the item in a second user interface, is operative to open the item in one of:
an editing stage user interface;
a viewing stage user interface; or
a consumption stage user interface.

17. A computer readable medium containing computer executable instructions which, when executed by a computer, perform a method for persistent feedback for bidirectional navigation, the method comprising:
launching an application;
providing a list of a plurality of application items in a staging user interface of the application;
receiving an indication of a selection to open an application item from the list in the staging user interface;
opening the application item in a second user interface, the second user interface comprising one of:
an editing stage user interface;
a viewing stage user interface; or
a consumption stage user interface;
receiving an indication of a selection to return to the staging user interface;
transitioning back to the staging user interface; and
providing a persistent visual indicator associated with the application item opened in the second user interface.

18. The computer readable medium of claim 17, wherein providing a persistent visual indicator associated with the item opened in the second user interface comprises providing a functionally selectable persistent visual indicator.

19. The computer readable medium of claim 18, further comprising:
receiving an indication of a selection of the functionally selectable persistent visual indicator; and
reopening the item in the second user interface.

20. The computer readable medium of claim 17, wherein receiving an indication of a selection to open an application item from the list in the staging user interface comprises receiving an indication of a selection via touch or gesture input.
